(19) United States
(12) Patent Application Publication
(10) Pub. No.: US 2022/0019942 A1
(43) Pub. Date: Jan. 20, 2022

(54) WORK SET SELECTING DEVICE, WORK SET SELECTION METHOD, AND WORK SET SELECTION PROGRAM

(71) Applicant: NEC Corporation, Minato-ku, Tokyo (JP)

(72) Inventor: Harumichi YOKOYAMA, Tokyo (JP)

(73) Assignee: NEC Corporation, Minato-ku, Tokyo (JP)

(21) Appl. No.: 17/312,639

(22) PCT Filed: Dec. 18, 2018
(86) PCT No.: PCT/JP2018/046503

§ 371 Date: Jun. 10, 2021

(51) Int. Cl. G06N 20/10; G06N 5/04

(52) U.S. Cl. CPC G06N 20/10; G06N 5/045

(57) ABSTRACT

A work set selecting device 10 includes: a sorting unit 11 which sorts feature quantities that correspond in a respective manner to a plurality of parameters to be optimized; and a selection unit 12 which selects, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

### TECHNICAL FIELD

The present invention relates to a work set selecting device, a work set selection method, and a work set selection program, and particularly relates to a work set selecting device, a work set selection method, and a work set selection program that can select a work set used for optimization by a support vector machine.

### BACKGROUND ART

Machine learning is a type of optimization problem for searching for such parameter values that minimize the value of an evaluation function determined from data. Optimization in machine learning is hereafter also simply referred to as “learning”.

An example of a useful machine learning algorithm is a support vector machine (SVM). The SVM is a widely used machine learning algorithm. The SVM uses a special function called kernel to convert features of data and perform learning.

A typical optimization technique by the SVM using a non-linear kernel is sequential minimum optimization (SMO). SMO optimizes as many parameters as data samples. That is, the number of parameters optimized is equal to the number of data samples. Hence, an increase in the number of data samples causes an increase in the time of learning by the SVM.

In learning by the SVM, the value of an evaluation function formed by a large number of parameters is often minimized. The number of parameters constituting the evaluation function is, for example, 100,000 or more.

For example, the number of samples of a dataset called covtype described in Non Patent Literature (NPL) 1 is about 400,000. In the case of using covtype for learning, SMO requires a lot of time to complete learning.

To shorten the time of learning by the SVM, there is a method of introducing parallel processing using a parallel computer into learning. An example is speeding up the SVM by a vector computer.

The vector computer is a computer that executes the same computation on a plurality of pieces of data in parallel to process the data at high speed. FIG. 13 is an explanatory diagram showing an example of computation by the vector computer.

For example, the vector computer adds the value of one element in array A [0:256] and the value of the corresponding element in array B [0:256]. The vector computer then writes the sum of the values of the two elements to the corresponding element in array C [0:256]. The vector computer performs the addition process and the write process for each element in parallel.

NPL 2 describes Thundersvm that performs a learning process by the SVM using a graphical processing unit (GPU) capable of high parallel processing.

FIG. 14 is an explanatory diagram showing an example of a learning process by the SVM. The learning process by the SVM includes a work set (shaded ellipse in FIG. 14, size M) selection process shown in FIG. 14. The work set selection process is a process of selecting, from all parameters (white ellipse in FIG. 14, size N) subjected to optimization by the SVM, a predetermined number (M) of parameters as a work set.

After selecting the work set, the SVM performs partial optimization on the parameters belonging to the selected work set. The partial optimization is a process of varying only the values of the parameters belonging to the work set while fixing the values of the parameters not belonging to the work set to minimize the value of an evaluation function.

After the partial optimization for one work set ends, the SVM performs the work set selection process for another work set. By repeatedly performing the work set selection process and the partial optimization on the selected work set, the SVM executes optimization on all of the parameters.

The reason of performing the learning process shown in FIG. 14 is because there are a large number of parameters subjected to optimization in machine learning. The SVM repeatedly executes the learning process of selecting a work set (e.g. approximately 1024 parameters) from all parameters and performing partial optimization until all parameters converge, i.e. the value of each parameter reaches an optimum value.

### CITATION LIST

### Non Patent Literatures

NPL 1: “UCI Machine Learning Repository: Covertype Data Set”, [online], UCI Machine Learning Repository, [searched on Oct. 15, 2018]

NPL 2: “GitHub-Xtra-Computing/thundersvm: ThunderSVM: A Fast SVM Library on GPUs and CPUs”, [online], GitHub, [searched on Oct. 15, 2018]

### SUMMARY OF INVENTION

### Technical Problem

The number of steps of computation required for optimization depends on the work set selection method. For example, the number of steps of computation until convergence is smaller in the case of selecting a work set from all parameters on the basis of a specific index than in the case of randomly selecting a work set from all parameters. Thus, a technique of selecting a work set from all parameters on the basis of a specific index is needed.

To solve the problem stated above, the present invention has an object of providing a work set selecting device, a work set selection method, and a work set selection program that can select a work set from all parameters on the basis of a specific index.

### Solution to Problem

A work set selecting device according to the present invention includes: a sorting unit which sorts feature quantities that correspond in a respective manner to a plurality of parameters to be optimized; and a selection unit which selects, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

A work set selection method according to the present invention includes: sorting feature quantities that correspond in a respective manner to a plurality of parameters to be optimized; and selecting, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

A work set selection program according to the present invention causes a computer to execute: a sorting process of sorting feature quantities that correspond in a respective manner to a plurality of parameters to be optimized; and a selection process of selecting, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

### Advantageous Effects of Invention

According to the present invention, it is possible to select a work set from all parameters on the basis of a specific index.

### BRIEF DESCRIPTION OF DRAWINGS

FIG. 1 is a block diagram showing an example of the configuration of the first exemplary embodiment of a work set selecting device according to the present invention.

FIG. 2 is a flowchart showing the operation of a work set selection process by a work set selecting device 100 of the first exemplary embodiment.

FIG. 3 is a block diagram showing an example of the configuration of the second exemplary embodiment of a work set selecting device according to the present invention.

FIG. 4 is an explanatory diagram showing an example of feature quantities corresponding to parameters belonging to an upper set I_up and a lower set I_low.

FIG. 5 is an explanatory diagram showing an example of selection of feature quantities corresponding to parameters belonging to the upper set I_up and the lower set I_low.

FIG. 6 is an explanatory diagram showing an example of a selection algorithm for feature quantities corresponding to parameters belonging to the upper set I_up and the lower set I_low.

FIG. 7 is an explanatory diagram showing an example of feature quantities corresponding to parameters belonging to the upper set I_up, the lower set I_low, and a set I_0.

FIG. 8 is an explanatory diagram showing another example of feature quantities corresponding to parameters belonging to the upper set I_up, the lower set I_low, and the set I_0.

FIG. 9 is an explanatory diagram showing another example of feature quantities corresponding to parameters belonging to the upper set I_up, the lower set I_low, and the set I_0.

FIG. 10 is a flowchart showing the operation of a work set selection process by a work set selecting device 200 of the second exemplary embodiment.

FIG. 11 is an explanatory diagram showing an example of the hardware structure of a work set selecting device according to the present invention.

FIG. 12 is a block diagram showing an overview of a work set selecting device according to the present invention.

FIG. 13 is an explanatory diagram showing an example of computation by the vector computer.

FIG. 14 is an explanatory diagram showing an example of a learning process by the SVM.

### DESCRIPTION OF EMBODIMENT

Exemplary embodiments of the present invention will be described below, with reference to drawings.

Prior to the description of each exemplary embodiment, the notation and the concepts required for the description will be introduced. In each exemplary embodiment, the number of all parameters is denoted by N, and the number of parameters selected as a work set (i.e. the size of the work set) is denoted by M.

The values of the N parameters are collectively denoted by a[1:N]. The i-th element of a[1:N] is a[i]. The respective feature quantities corresponding to the N parameters are collectively denoted by f[1:N]. The i-th element of f[1:N] is f[i]. A feature quantity is a quantity that changes during learning.

N elements other than the values of the parameters and the feature quantities may also be collectively expressed using “[1:N]”.

A work set S is expressed as a set of indices of the parameters belonging to the work set S. A set of all parameters is denoted by S0. That is, S0={1, 2, 3, . . . , N}. [0028]

### First Exemplary Embodiment.

[Description of Configuration]

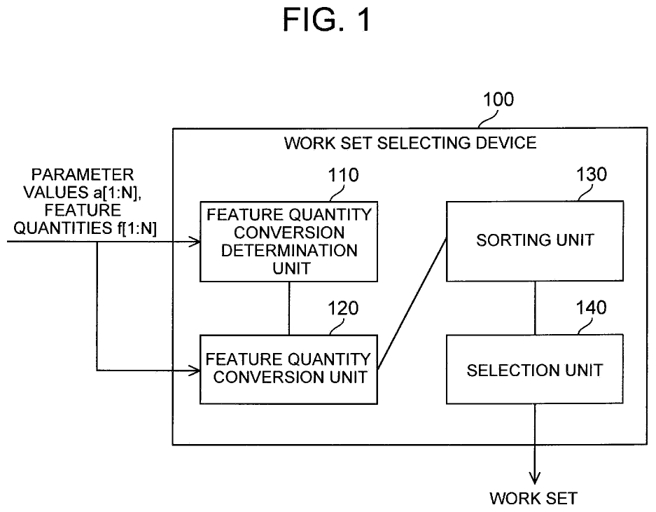

A first exemplary embodiment of a work set selecting device according to the present invention will be described below, with reference to drawings. FIG. 1 is a block diagram showing an example of the configuration of the first exemplary embodiment of a work set selecting device according to the present invention. As shown in FIG. 1, a work set selecting device 100 includes a feature quantity conversion determination unit 110, a feature quantity conversion unit 120, a sorting unit 130, and a selection unit 140.

The work set selecting device 100 receives parameter values a[1:N], feature quantities f[1:N], and a work set size M as input. The work set selecting device 100 returns, in response to the received input, a work set S to which M parameters from among all parameters belong, as output.

The feature quantity conversion determination unit 110 has a function of determining, independently for every parameter, whether to convert a feature quantity corresponding to the parameter. The feature quantity conversion determination unit 110 receives the parameter values a[1:N] and the feature quantities f[1:N] as input, and returns, as output, an array bf[1:N] to which N truth values are assigned.

The i-th element bf[i] of the array bf[1:N] is decided by the value a[i] of the i-th parameter (hereafter referred to as “parameter i”) and the feature quantity f[i] corresponding to the parameter i. The truth value assigned to the element bf[i] indicates converting the feature quantity f[i] if it is true, and indicates not converting the feature quantity f[i] if it is false.

The feature quantity conversion unit 120 has a function of converting a feature quantity independently for each parameter on the basis of the output of the feature quantity conversion determination unit 110. The reason of converting the feature quantity is to parallelize the work set selection process.

The feature quantity conversion unit 120 receives the parameter values a[1:N], the feature quantities f[1:N], and the output bf[1:N] of the feature quantity conversion determination unit 110 as input, and returns, as output, an array xf[1:N] to which converted feature quantities are assigned.

For example, the feature quantity conversion unit 120 holds a feature quantity conversion function. The feature quantity conversion function receives the value a[j] of a parameter j and the feature quantity f[j], and returns a converted feature quantity.

For a parameter i, if the truth value assigned to the element bf[i] is true, the feature quantity conversion unit 120 inputs the value a[i] of the parameter and the feature quantity f[i] to the feature quantity conversion function. The feature quantity conversion unit 120 then assigns the output of the feature quantity conversion function to the element xf[i]. If the truth value assigned to the element bf[i] is false, the feature quantity conversion unit 120 assigns the feature quantity f[i] directly to the element xf[i].

The sorting unit 130 has a function of sorting the feature quantities including the converted feature quantities output from the feature quantity conversion unit 120, in ascending order or descending order of converted feature quantities. Specifically, the sorting unit 130 receives the array xf[1:N] output from the feature quantity conversion unit 120, as input. The sorting unit 130 then sorts the array xf[1:N] using the values of the array xf[:N] as keys.

Following this, the sorting unit 130 sets an array of keys (converted feature quantities) after the sorting as sxf[1:N], and an array of indices (parameter numbers) after the sorting as sid[1:N]. That is, for xf, sxf, and sid, the relationship sxf[i]=xf[sid[i]] holds. The sorting unit 130 returns the array sxf[1:N] of the sorted keys and the array sid[1:N] of the sorted indices, as output.

The selection unit 140 has a function of selecting parameters corresponding to a predetermined number of feature quantities from the first element of the array of the sorted converted feature quantities. Specifically, the selection unit 140 receives the array sxf[1:N] and the array sid[1:N] output from the sorting unit 130, as input. The selection unit 140 then selects the first to M-th elements of the array sid[1:N], i.e. an array sid[1:M]. After this, the selection unit 140 outputs the selected array sid[1:M] as the work set S. The selection unit 140 may select the predetermined number of elements from the N-th element of the array sid[1:N] in descending order.

[Description of Operation]

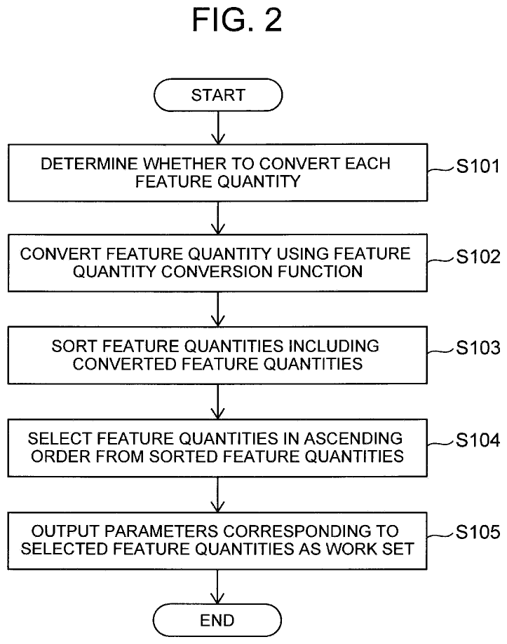

The operation of selecting a work set by the work set selecting device 100 of the present exemplary embodiment will be described below, with reference to FIG. 2. FIG. 2 is a flowchart showing the operation of a work set selection process by the work set selecting device 100 of the first exemplary embodiment.

First, the feature quantity conversion determination unit 110 receives the parameter values a[1:N] and the feature quantities f[1:N] as input. The feature quantity conversion determination unit 110 determines, for each feature quantity, whether to convert the feature quantity, on the basis of the parameter values a[1:N] and the feature quantities f[1:N] (step S101).

Next, the feature quantity conversion determination unit 110 assigns a truth value to each element of the array bf[1:N], on the basis of the corresponding determination result. The feature quantity conversion determination unit 110 then inputs the array bf[1:N] to which N truth values are assigned, to the feature quantity conversion unit 120.

Next, the feature quantity conversion unit 120 receives the parameter values a[1:N] and the feature quantities f[1:N] as input. The feature quantity conversion unit 120 then converts each feature quantity using the feature quantity conversion function, on the basis of the array bf[1:N] received from the feature quantity conversion determination unit 110 (step S102).

Specifically, the feature quantity conversion unit 120 inputs the value a[i] and the feature quantity f[i] of each parameter i for which the truth value assigned to the element bf[i] is true, to the feature quantity conversion function. The feature quantity conversion unit 120 then assigns the output of the feature quantity conversion function to the element xf[i]. The feature quantity conversion unit 120 assigns the feature quantity f[i] of each parameter i for which the truth value assigned to the element bf[i] is false, directly to the element xf[i].

The feature quantity conversion unit 120 assigns a feature quantity to each element of the array xf[1:N] in the above-described manner. The feature quantity conversion unit 120 then inputs the array xf[1:N] to which N feature quantities including converted feature quantities are assigned, to the sorting unit 130.

Next, the sorting unit 130 receives the array xf[1:N] to which N feature quantities are assigned, as input. The sorting unit 130 then sorts the feature quantities including converted feature quantities (step S103). Specifically, the sorting unit 130 sorts the array xf[1:N] using the values of the array xf[1:N] as keys. The sorting unit 130 may sort the array xf[1:N] in any of ascending order and descending order.

Next, the sorting unit 130 assigns the sorted keys to the respective elements of the array sxf[1:N]. The sorting unit 130 also assigns the sorted indices to the respective elements of the array sid[1:N]. The sorting unit 130 then inputs the array sxf[1:N] to which N keys are assigned and the array sid[1:N] to which N indices are assigned, to the selection unit 140.

Next, the selection unit 140 receives the array sxf[1:N] and the array sid[1:N] as input. The selection unit 140 then selects feature quantities in ascending order from the sorted feature quantities (keys) (step S104).

Next, the selection unit 140 outputs the parameters corresponding to the selected feature quantities, as the work set S (step S105). Specifically, the selection unit 140 selects the first to M-th elements of the array sid[1:N], i.e. the array sid[1:M].

The selection unit 140 then outputs the selected array sid[1:M] as the work set S. After the output, the work set selecting device 100 ends the work set selection process.

In steps S104 to S105, the selection unit 140 may select feature quantities from the sorted feature quantities (keys) in descending order, and output the parameters corresponding to the selected feature quantities as the work set S. Specifically, the selection unit 140 may select the N-th to (N−(M−1))-th elements of the array sid[1:N], i.e. the array sid[N−(M−1):N].

[Description of Effects]

In the work set selecting device 100 of the present exemplary embodiment, the selection unit 140 selects a work set on the basis of a criterion that parameters corresponding to feature quantities selected from sorted feature quantities in ascending order or descending order are included in the work set. Thus, the work set selecting device 100 can select a work set from all parameters on the basis of a specific index.

Moreover, in the work set selecting device 100 of the present exemplary embodiment, the feature quantity conversion determination unit 110 determines whether to convert a feature quantity, independently for each parameter. Likewise, the feature quantity conversion unit 120 performs feature quantity conversion independently for each parameter.

The sorting process by the sorting unit 130 is known to be executable in parallel by existing techniques. The process of selecting elements from the sorted array by the selection unit 140 is also executable in parallel. Therefore, the work set selecting device 100 of the present exemplary embodiment can parallelize the work set selection process in the learning process by the SVM.

### Second Exemplary Embodiment.

[Description of Configuration]

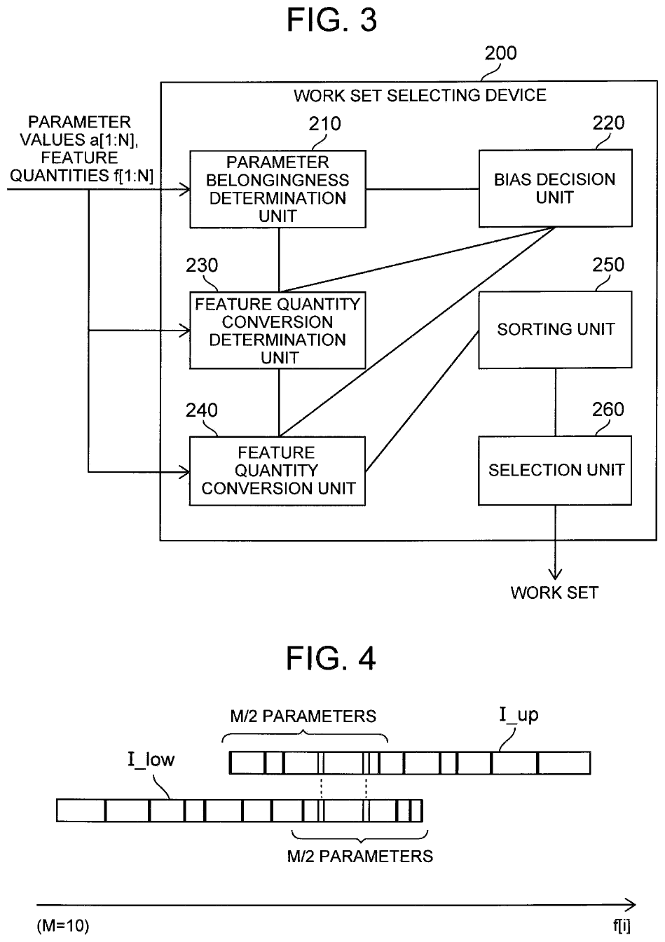

A second exemplary embodiment of a work set selecting device according to the present invention will be described below, with reference to drawings. FIG. 3 is a block diagram showing an example of the configuration of the second exemplary embodiment of a work set selecting device according to the present invention.

As shown in FIG. 3, a work set selecting device 200 of the present exemplary embodiment includes a parameter belongingness determination unit 210, a bias decision unit 220, a feature quantity conversion determination unit 230, a feature quantity conversion unit 240, a sorting unit 250, and a selection unit 260.

As in the first exemplary embodiment, the work set selecting device 200 receives parameter values a[1:N], feature quantities f[1:N], and a work set size M as input. The work set selecting device 200 returns, in response to the received input, a work set S to which M parameters from among all parameters belong, as output.

In the present exemplary embodiment, each parameter belongs to at least one set out of an upper set I_up and a lower set I_low. The upper set I_up and the lower set I_low are sets relating to the learning process by the SVM. Whether a parameter i belongs to the upper set I_up or the lower set I_low is automatically decided by the SVM.

There are parameters belonging to both the upper set I_up and the lower set I_low. That is, a sum set of the upper set I_up and the lower set I_low corresponds to a set S0 of all parameters.

A common part of the upper set I_up and the lower set I_low is normally not an empty set. The common part of the upper set I_up and the lower set I_low is hereafter denoted by I_0.

In a typical SVM algorithm, work set selection and parameter update alternate repeatedly. When a parameter changes, whether the changed parameter belongs to the upper set I_up or the lower set I_low changes, too. That is, for each work set selection process, which parameters belong to the upper set I_up and which parameters belong to the lower set I_low change.

FIG. 4 is an explanatory diagram showing an example of feature quantities corresponding to parameters belonging to the upper set I_up and the lower set I_low. FIG. 4 shows an example in which the size M of the work set selected is 10.

Each vertical line in the upper set I_up shown in FIG. 4 represents a feature quantity corresponding to a parameter belonging to the upper set I_up. Each vertical line in the lower set I_low shown in FIG. 4 represents a feature quantity corresponding to a parameter belonging to the lower set I_low. Each double line in the upper set I_up and the lower set I_low shown in FIG. 4 represents a feature quantity corresponding to a parameter belonging to both the upper set I_up and the lower set I_low.

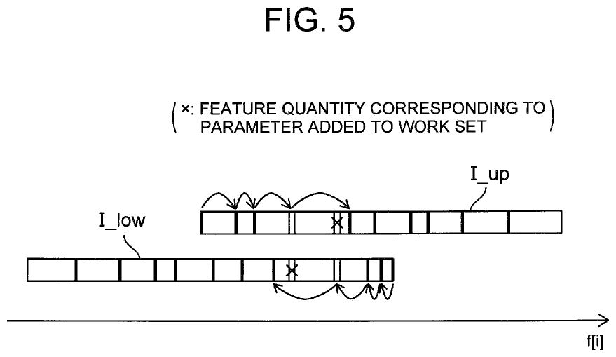

A work set selection method of determining the number of steps of computation required for optimization in the present exemplary embodiment will be described below. FIG. 5 is an explanatory diagram showing an example of selection of feature quantities corresponding to parameters belonging to the upper set I_up and the lower set I_low.

It is known that the number of steps until convergence is relatively small if a work set of the size M is selected by selecting M/2 corresponding parameters from the feature quantities f[i] in the upper set I_up in ascending order and selecting M/2 corresponding parameters from the feature quantities f[i] in the lower set I_low in descending order, as shown in FIG. 5. The selection method shown in FIG. 5 simultaneously checks the feature quantities for the upper set I_up one by one in ascending order and the feature quantities for the lower set I_low one by one in descending order.

If a parameter corresponding to a checked feature quantity is not added to the work set, the selection method adds the parameter to the work set. After the addition, the selection method places a mark indicating that the parameter is added to the work set, on the corresponding feature quantity. In FIG. 5, “×” is the mark indicating that the parameter is added to the work set.

The reason of placing the mark indicating that the parameter is added to the work set is as follows: There are parameters belonging to both the upper set I_up and the lower set I_low, as shown in FIGS. 4 and 5. There is thus a possibility that, unless whether each parameter belonging to both the upper set I_up and the lower set I_low has already been selected as the work set is sequentially checked in both the selection from the upper set I_up and the selection from the lower set I_low, any parameter belonging to both the upper set I_up and the lower set I_low is stored in the work set overlappingly (i.e. stored more than once).

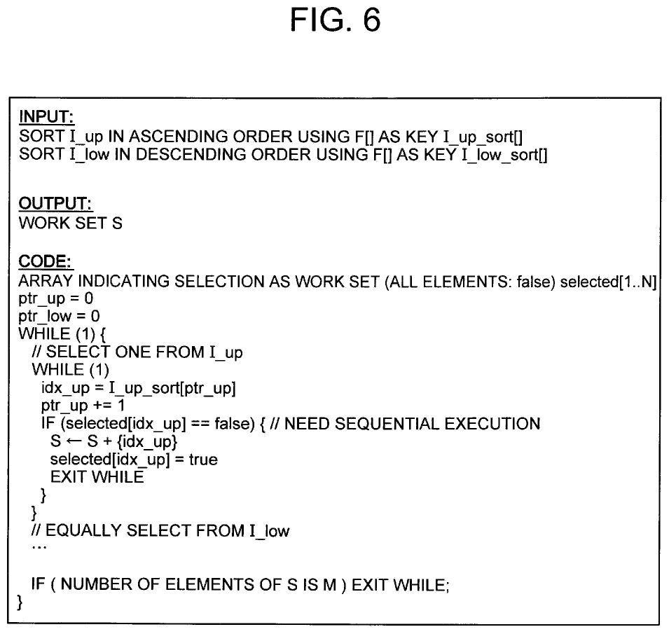

FIG. 6 is an explanatory diagram showing an example of a selection algorithm for feature quantities corresponding to parameters belonging to the upper set I_up and the lower set I_low. The selection algorithm shown in FIG. 6 is an algorithm for executing the foregoing selection process. The number of elements of an array selected[idx_up] representing that parameters are added to a work set shown in FIG. 6 is equal to the total number (N) of parameters.

In the case where the selection method shown in FIGS. 5 and 6 is used, it is difficult to parallelize the work set selection process without changing the number of steps to reach predetermined accuracy. If the selection method shown in FIGS. 5 and 6 is not used and the parameters included in the work set are randomly selected from all parameters without such as values of the parameters being taken into consideration, the work set selection process is parallelized.

However, the method of randomly selecting parameters requires a large number of steps to reach the predetermined accuracy, so that the time required for the learning process by the SVM increases. The work set selecting device 200 of the present exemplary embodiment is mainly intended to parallelize the work set selection process without significantly changing the number of steps to reach the predetermined accuracy, even in the case of using the selection method shown in FIGS. 5 and 6.

The parameter belongingness determination unit 210 has a function of determining, for each parameter, whether the parameter belongs to the upper set I_up and the lower set I_low.

For example, for a parameter i, the parameter belongingness determination unit 210 decides a truth value assigned to an element is_I_up[i] and a truth value assigned to an element is_I_low[i], using a predetermined function having the value a[i] of the parameter i and the feature quantity f[i] corresponding to the parameter i as input.

When the truth value assigned to the element is_I_up[i] is true, the parameter i belongs to the upper set I_up. When the truth value assigned to the element is_I_up[i] is false, the parameter i does not belong to the upper set I_up.

Likewise, when the truth value assigned to the element is_I_low[i] is true, the parameter i belongs to the lower set I_low. When the truth value assigned to the element is_I_low[i] is false, the parameter i does not belong to the lower set I_low.

The parameter belongingness determination unit 210 decides the respective truth values assigned to the two elements, for each parameter. The parameter belongingness determination unit 210 returns an array is_I_up[1:N] to which the decided N truth values are assigned and an array is_I_low[1:N] to which the decided N truth values are assigned, as output.

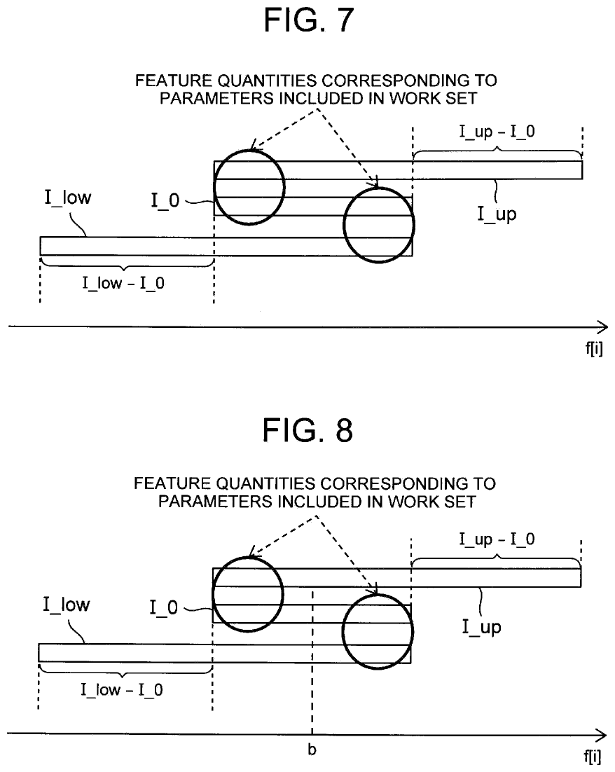

FIG. 7 is an explanatory diagram showing an example of feature quantities corresponding to parameters belonging to the upper set I_up, the lower set I_low, and the set I_0. In FIG. 7, I_up-I_0 is a set of feature quantities corresponding to parameters that belong to the upper set I_up and do not belong to the lower set I_low.

In FIG. 7, I_low-I_0 is a set of feature quantities corresponding to parameters that belong to the lower set I_low and do not belong to the upper set I_up. In FIG. 7, feature quantities within two ellipses are feature quantities corresponding to parameters included in the work set.

The bias decision unit 220 has a function of deciding a bias that is a representative value of the feature quantities f[1:N] on the basis of the set to which each parameter belongs. The bias is an intermediate value of the feature quantities f[I_0] corresponding to the parameters that belong to the set I_0. Of the feature quantities f[1:N] corresponding to all parameters, an array of feature quantities corresponding to parameters belonging to a set X is denoted by f[X].

The bias decision unit 220 receives, as input, the array is_I_up[1:N] and the array is_I_low[1:N] output from the parameter belongingness determination unit 210, and extracts the set I_0. The bias decision unit 220 then decides a bias b on the basis of the extracted set I_0. There are a plurality of methods of deciding the bias b. Examples of such decision methods will be described below.

The first decision method decides an average value of f[I_0] as the bias b. In the case of deciding the average value as the bias b, the bias decision unit 220 first initializes each of a variable sum and a variable count to 0.

The bias decision unit 220 then determines, for each parameter, whether the element is_I_up[i] is true and the element is_I_low[i] is true. The bias decision unit 220 adds the feature quantity f[i] of the parameter i for which both truth values are true, to the variable sum. The bias decision unit 220 also adds 1 to the variable count.

After completing the determination and the addition for all parameters, the bias decision unit 220 sets the quotient obtained by dividing the variable sum by the variable count, as the bias b.

FIG. 8 is an explanatory diagram showing another example of feature quantities corresponding to parameters belonging to the upper set I_up, the lower set I_low, and the set I_0. The bias b shown in FIG. 8 is the bias obtained by the first decision method based on the set I_0.

The second decision method decides an intermediate value between a maximum value and a minimum value of f[I_0] as the bias b. In the case of deciding the intermediate value as the bias b, the bias decision unit 220 first sorts f[I_0].

The bias decision unit 220 then sets the quotient obtained by dividing the sum of the value of the first element and the value of the last element (the maximum value and the minimum value) of the sorted array by 2, as the bias b. The method of deciding the bias b is not limited to the examples described above.

The feature quantity conversion determination unit 230 has a function of determining, independently for every parameter, whether to convert a feature quantity corresponding to the parameter. The feature quantity conversion determination unit 230 receives the array is_I_up[1:N] and the array is_I_low[1:N] output from the parameter belongingness determination unit 210 and the bias b output from the bias decision unit 220, as input.

The feature quantity conversion determination unit 230 returns the array bf[1:N] to which the N truth values indicating whether to convert the feature quantities corresponding to the respective parameters are assigned, as output.

For a parameter i, for example, the feature quantity conversion determination unit 230 sets the truth value assigned to the element bf[i] as true if a condition A is satisfied, and sets the truth value assigned to the element bf[i] to false if the condition A is not satisfied. The condition A is ((is_I_low[i]=true) or (is_I_low[i]=true and is_I_up[i]=true and f[i]>b))

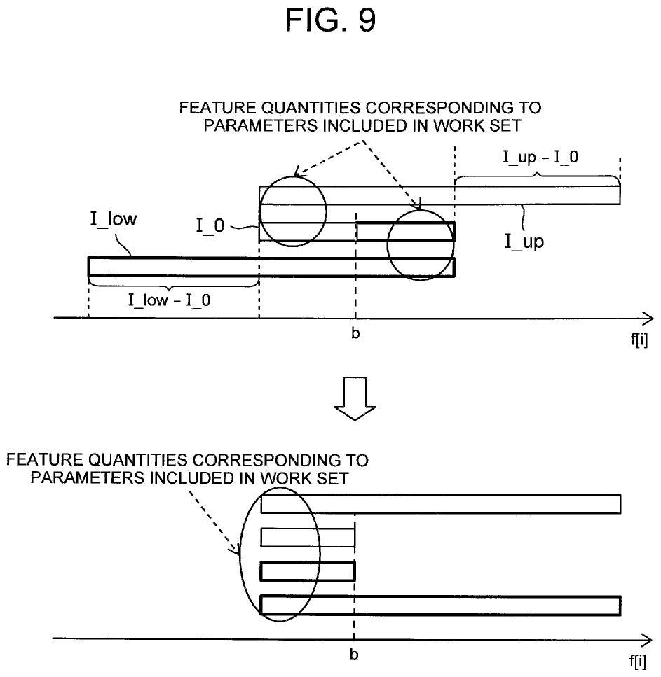

FIG. 9 is an explanatory diagram showing another example of feature quantities corresponding to parameters belonging to the upper set I_up, the lower set I_low, and the set I_0. The thick frame corresponding to the lower set I_low shown in the upper of FIG. 9 represents a set of feature quantities corresponding to parameters that satisfy (is_I_low[i]=true) in the condition A.

The thick frame in the set I_0 shown in the upper of FIG. 9 represents a set of feature quantities corresponding to parameters that satisfy (is_I_low[i]=true and is_I_up[i]=true and f[i]>b) in the condition A. That is, the set of feature quantities represented by the thick frame in the set I_0 corresponds to a set of parameters that are included in the set I_0 and whose feature quantities are greater than the bias b.

The feature quantity conversion unit 240 has a function of, independently for every parameter, converting a feature quantity according to a predetermined condition on the basis of the output of the feature quantity conversion determination unit 230. The feature quantity conversion unit 240 receives, as input, bf[1:N] output from the feature quantity conversion determination unit 230 and the bias b output from the bias decision unit 220, and returns, as output, the array xf[1:N] to which N feature quantities including converted feature quantities are assigned.

The feature quantity conversion unit 240 assigns, for each parameter i for which the truth value assigned to the element bf[i] is true, a value (2*b−f[i]) obtained by inverting the feature quantity f[i] with respect to the bias b, to the element xf[i]. The feature quantity conversion unit 240 assigns, for each parameter i for which the truth value assigned to the element bf[i] is false, the feature quantity f[i] directly to the element xf[i].

As shown in the lower of FIG. 9, the set of feature quantities corresponding to parameters that satisfy the condition A is inverted with respect to the bias b. The third thick frame from the top shown in the lower of FIG. 9 represents a set obtained by inverting the set of feature quantities represented by the thick frame in the set I_0 shown in the upper of FIG. 9. The fourth rectangle from the top shown in the lower of FIG. 9 represents a set obtained by inverting the set of feature quantities corresponding to the parameters belonging to the lower set I_low shown in the upper of FIG. 9.

The sorting unit 250 has a function of sorting the feature quantities including the converted feature quantities output from the feature quantity conversion unit 240, in ascending order or descending order of converted feature quantities. That is, the sorting unit 250 has the same function as the sorting unit 130 in the first exemplary embodiment.

The selection unit 260 has a function of selecting parameters corresponding to a predetermined number of feature quantities from the first element of the array of the sorted converted feature quantities. That is, the selection unit 260 has the same function as the selection unit 140 in the first exemplary embodiment.

Even in the case where the selection unit 260 checks the feature quantities represented by the first rectangle from the top in the ellipse and the feature quantities represented by the fourth rectangle from the top in the ellipse shown in the lower of FIG. 9 in parallel in ascending order, the selection unit 260 is unlikely to check the same feature quantity. This is because the order of feature quantities is uniquely set by the sorting unit 250. Hence, the selection unit 260 can execute the work set selection process in parallel.

[Description of Operation]

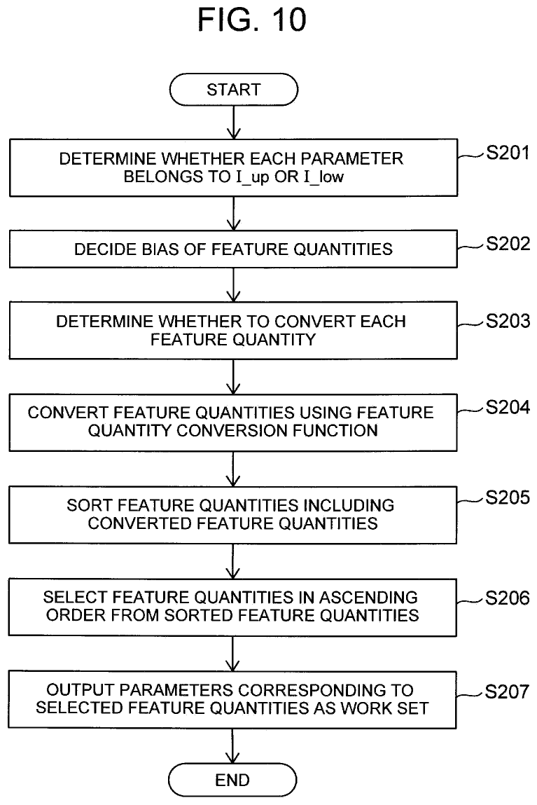

The operation of selecting a work set by the work set selecting device 200 of the present exemplary embodiment will be described below, with reference to FIG. 10. FIG. 10 is a flowchart showing the operation of a work set selection process by the work set selecting device 200 of the second exemplary embodiment.

First, the parameter belongingness determination unit 210 receives the parameter values a[1:N] and the feature quantities f[1:N] as input. The parameter belongingness determination unit 210 determines, for each parameter, whether the parameter belongs to the upper set I_up or the lower set I_low, on the basis of the parameter values a[1:N] and the feature quantities f[1:N] (step S201).

The parameter belongingness determination unit 210 then assigns a truth value to each element of the array is_I_up[1:N], on the basis of the corresponding determination result. The parameter belongingness determination unit 210 also assigns a truth value to each element of the array is_I_low[1:N], on the basis of the corresponding determination result. Next, the parameter belongingness determination unit 210 inputs the array is_I_up[1:N] to which the N truth values are assigned and the array is_I_low[1:N] to which the N truth values are assigned, to the bias decision unit 220 and the feature quantity conversion determination unit 230.

Next, the bias decision unit 220 receives the array is_I_up[1:N], the array is_I_low[1:N], and the feature quantities f[1:N] from the parameter belongingness determination unit 210, as input. The bias decision unit 220 then decides the bias b of the parameters belonging to the set I_0, on the basis of the array is_I_up[1:N] and the array is_I_low[1:N] (step S202). Next, the bias decision unit 220 inputs the decided bias b to the feature quantity conversion determination unit 230 and the feature quantity conversion unit 240.

Next, the feature quantity conversion determination unit 230 receives the parameter values a[1:N], the feature quantities f[1:N], the array is_I_up[1:N], the array is_I_low[1:N], and the bias b, as input. The feature quantity conversion determination unit 230 determines, for each feature quantity, whether to convert the feature quantity, on the basis of the input values (step S203).

Next, the feature quantity conversion determination unit 230 assigns a truth value to each element of the array bf[1:N], on the basis of the corresponding determination result. The feature quantity conversion determination unit 230 then inputs the array bf[1:N] to which N truth values are assigned, to the feature quantity conversion unit 240.

Next, the feature quantity conversion unit 240 receives the parameter values a[1:N] and the feature quantities f[1:N] as input. The feature quantity conversion unit 240 then converts each feature quantity using the feature quantity conversion function, on the basis of the bias b received from the bias decision unit 220 and the array bf[1:N] received from the feature quantity conversion determination unit 230 (step S204).

Specifically, the feature quantity conversion unit 240 assigns the value (2*b−f[i]) obtained by inverting the feature quantity f[i] of each parameter i for which the truth value assigned to the element bf[i] is true with respect to the bias b, to the element xf[i]. The feature quantity conversion unit 240 assigns the feature quantity f[i] of each parameter i for which the truth value assigned to the element bf[i] is false, directly to the element xf[i].

The feature quantity conversion unit 240 assigns a feature quantity to each element of the array xf[1:N] in the above-described manner. The feature quantity conversion unit 240 then inputs the array xf[1:N] to which N feature quantities including converted feature quantities are assigned, to the sorting unit 250.

Next, the sorting unit 250 receives the array xf[1:N] to which N feature quantities are assigned, as input. The sorting unit 250 then sorts the feature quantities including converted feature quantities (step S205). Specifically, the sorting unit 250 sorts the array xf[1:N] using the values of the array xf[1:N] as keys. The sorting unit 250 may sort the array xf[1:N] in any of ascending order and descending order.

Next, the sorting unit 250 assigns the sorted keys to the respective elements of the array sxf[1:N]. The sorting unit 250 also assigns the sorted indices to the respective elements of the array sid[1:N]. The sorting unit 250 then inputs the array sxf[1:N] to which N keys are assigned and the array sid[1:N] to which N indices are assigned, to the selection unit 260.

Next, the selection unit 260 receives the array sxf[1:N] and the array sid[1:N] as input. The selection unit 260 then selects feature quantities in ascending order from the sorted feature quantities (keys) (step S206).

Next, the selection unit 260 outputs the parameters corresponding to the selected feature quantities, as the work set S (step S207). Specifically, the selection unit 260 selects the first to M-th elements of the array sid[1:N], i.e. the array sid[1:M].

The selection unit 260 then outputs the selected array sid[1:M] as the work set S. After the output, the work set selecting device 200 ends the work set selection process.

In steps 5206 to 5207, the selection unit 260 may select feature quantities from the sorted feature quantities (keys) in descending order, and output the parameters corresponding to the selected feature quantities as the work set S. Specifically, the selection unit 260 may select the N-th to (N−(M−1))-th elements of the array sid[1:N], i.e. the array sid[N−(M−1):N].

[Description of Effects]

With Thundersvm described in NPL 2, many processes other than the work set selection process are executed by a GPU, and the work set selection process is executed by a central processing unit (CPU) that hosts the GPU. The specific details are described in function CSMOSolver::select_working_set in file src/thundersvm/csmosolver.cpp.

In other words, the function describes sequentially performing the work set selection process. Therefore, simply executing the work set selection process by the GPU is no parallel processing. Since it is difficult for the GPU to execute sequential processing speedily, the time for the work set selection process is expected to be long.

Thus, NPL 2 has no mention of a method capable of parallelizing a work set selection process without increasing the number of steps until convergence in the learning process by the SVM.

The work set selecting device 200 of the present exemplary embodiment can parallelize the work set selection process without a decrease in the convergence performance of the SVM. This is because the feature quantity conversion unit 240 converts a set of feature quantities and the sorting unit 250 sorts feature quantities including converted feature quantities so as to prevent overlapping selection of feature quantities corresponding to parameters belonging to both the upper set I_up and the lower set I_low. Thus, the work set selecting device 200 can parallelize the work set selection process without increasing the number of steps until convergence in the learning process by the SVM.

As a result of incorporating the work set selecting device 200 into existing implementation and evaluating the convergence performance of the SVM, the variation of the number of steps until convergence was within 5%. That is, the work set selecting device 200 that selects a work set according to the modified algorithm of the selection algorithm shown in FIG. 6 can parallelize the work set selection process with no substantial change in the number of steps to reach predetermined accuracy. In other words, a vector computer having the structure of the work set selecting device 200 can execute a learning process by the SVM without a decrease in processing performance.

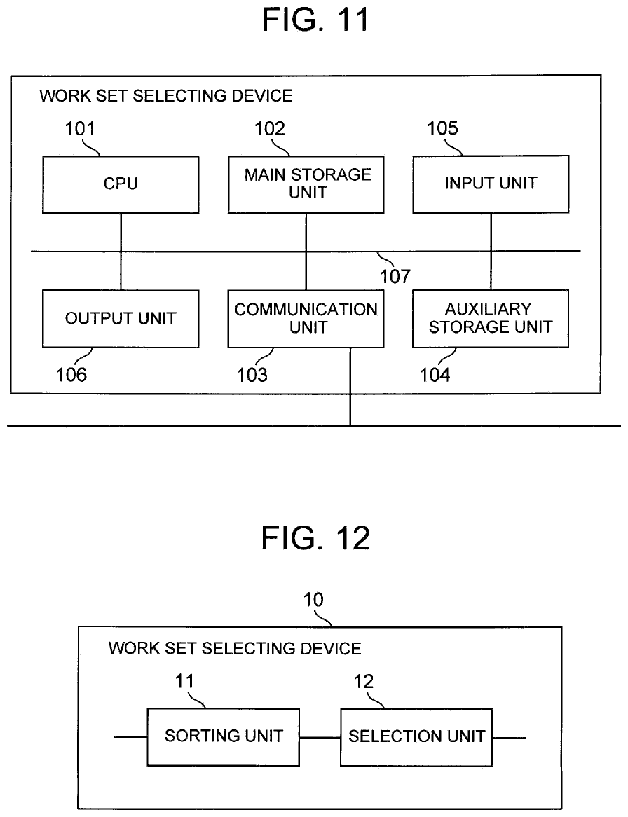

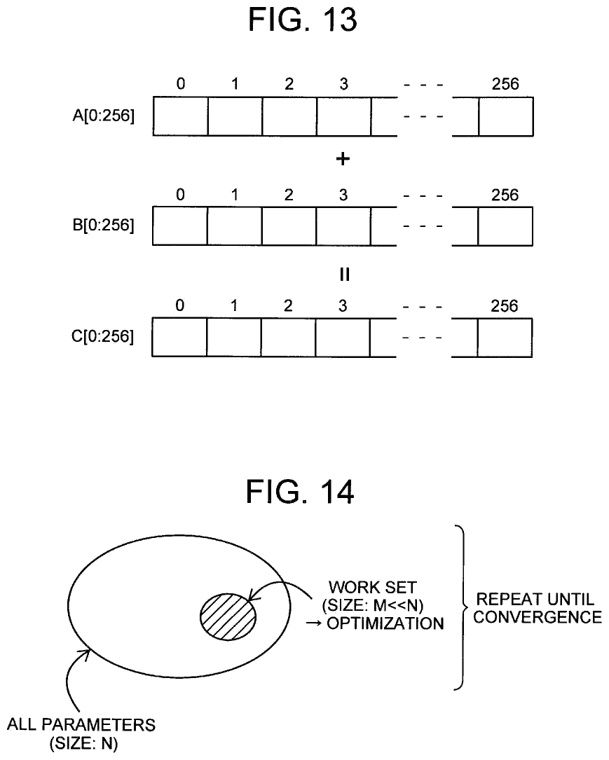

A specific example of the hardware structure of the work set selecting device according to each of the exemplary embodiments will be described below. FIG. 11 is an explanatory diagram showing an example of the hardware structure of a work set selecting device according to the present invention.

The work set selecting device shown in FIG. 11 includes a CPU 101, a main storage unit 102, a communication unit 103, and an auxiliary storage unit 104. The work set selecting device may also include an input unit 105 for user operation and an output unit 106 for presenting processing results or the progress of processing to a user.

The work set selecting device is realized by software, by the CPU 101 shown in FIG. 11 executing a program that provides the functions of the components.

In detail, the functions are realized by software, by the CPU 101 loading a program stored in the auxiliary storage unit 104 into the main storage unit 102 and executing the program to control the operation of the work set selecting device.

The work set selecting device shown in FIG. 11 may include a digital signal processor (DSP) instead of the CPU 101. The work set selecting device shown in FIG. 11 may include both the CPU 101 and the DSP.

The main storage unit 102 is used as a work area for data or a temporary save area for data. The main storage unit 102 is, for example, random access memory (RAM).

The communication unit 103 has a function of performing data input and output with peripheral devices via a wire network or a wireless network (information communication network).

The auxiliary storage unit 104 is a non-transitory tangible storage medium. Examples of the non-transitory tangible storage medium include a magnetic disk, a magneto-optical disk, compact disk read only memory (CD-ROM), digital versatile disk read only memory (DVD-ROM), and semiconductor memory.

The input unit 105 has a function of inputting data and processing instructions. The input unit 105 is, for example, an input device such as a keyboard and a mouse.

The output unit 106 has a function of outputting data. The output unit 106 is, for example, a display device such as a liquid crystal display device or a printing device such as a printer.

In the work set selecting device, each component is connected to a system bus 107, as shown in FIG. 11.

The auxiliary storage unit 104 stores, for example, a program for realizing the feature quantity conversion determination unit 110, the feature quantity conversion unit 120, the sorting unit 130, and the selection unit 140 in the first exemplary embodiment. The auxiliary storage unit 104 stores, for example, a program for realizing the parameter belongingness determination unit 210, the bias decision unit 220, the feature quantity conversion determination unit 230, the feature quantity conversion unit 240, the sorting unit 250, and the selection unit 260 in the second exemplary embodiment.

The work set selecting device may be realized by hardware. For example, the work set selecting device 100 may be implemented by circuitry including a hardware component such as LSI (Large Scale Integration) in which the functions shown in FIG. 1 are realized.

All or part of the components may be implemented by general-purpose or dedicated circuitry, processors, or combinations thereof. They may be configured with a single chip (e.g. the foregoing LSI), or configured with a plurality of chips connected via a bus. All or part of the components may be implemented by a combination of the above-mentioned circuitry or the like and program.

In the case where all or part of the components is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

An overview of the present invention will be described below. FIG. 12 is a block diagram showing an overview of a work set selecting device according to the present invention. A work set selecting device 10 according to the present invention includes: a sorting unit 11 (e.g. sorting unit 130) which sorts feature quantities that correspond in a respective manner to a plurality of parameters to be optimized; and a selection unit 12 (e.g. selection unit 140) which selects, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity. The work set selecting device 10 receives the parameter and the feature quantities corresponding to the parameters as input.

With such a structure, the work set selecting device can select a work set from all parameters on the basis of a specific index.

The work set selecting device 10 may include: a determination unit (e.g. feature quantity conversion determination unit 110) which determines, for each of the feature quantities that correspond in a respective manner to the plurality of parameters, whether to convert the feature quantity, according to a predetermined condition; and a conversion unit (e.g. feature quantity conversion unit 120) which converts the feature quantity determined to be converted, using a predetermined conversion function. The sorting unit 11 may sort the feature quantities including the converted feature quantity.

With such a structure, the work set selecting device can prevent overlapping selection of feature quantities corresponding to parameters belonging to both the upper set I_up and the lower set I_low.

The work set selecting device 10 may include a decision unit which decides a representative value of the feature quantities. The work set selecting device 10 may include a belongingness determination unit which determines, for each of the plurality of parameters, whether the parameter belongs to a predetermined set.

With such a structure, the work set selecting device can determine whether to convert each feature quantity, on the basis of the output of the belongingness determination unit and the output of the decision unit. The work set selecting device can also convert each feature quantity, on the basis of the output of the determination unit, the output of the belongingness determination unit, and the output of the decision unit.

The optimization may be performed by a support vector machine.

With such a structure, the work set selecting device can parallelize the work set selection process without increasing the number of steps until convergence in the learning process by the SVM.

### REFERENCE SIGNS LIST

10, 100, 200 Work set selecting device

11, 130, 250 Sorting unit

12, 140, 260 Selection unit

101 CPU

102 Main storage unit

103 Communication unit

104 Auxiliary storage unit

105 Input unit

106 Output unit

107 System bus

110, 230 Feature quantity conversion determination unit

120, 240 Feature quantity conversion unit

210 Parameter belongingness determination unit

220 Bias decision unit

What is claimed is:

1. A work set selecting device comprising:
a sorting unit which sorts feature quantities that correspond in a respective manner to a plurality of parameters to be optimized; and
a selection unit which selects, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

2. The work set selecting device according to claim 1, comprising:
a determination unit which determines, for each of the feature quantities that correspond in a respective manner to the plurality of parameters, whether to convert the feature quantity, according to a predetermined condition; and
a conversion unit which converts the feature quantity determined to be converted, using a predetermined conversion function.

3. The work set selecting device according to claim 2, wherein the sorting unit sorts the feature quantities including the converted feature quantity.

4. The work set selecting device according to claim 1, comprising
a decision unit which decides a representative value of the feature quantities.

5. The work set selecting device according to claim 1, comprising
a belongingness determination unit which determines, for each of the plurality of parameters, whether the parameter belongs to a predetermined set.

6. The work set selecting device according to claim 1, wherein the optimization is performed by a support vector machine.

7. A work set selection method comprising:
sorting feature quantities that correspond in a respective manner to a plurality of parameters to be optimized; and
selecting, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

8. The work set selection method according to claim 7, comprising:
determining, for each of the feature quantities that correspond in a respective manner to the plurality of parameters, whether to convert the feature quantity, according to a predetermined condition; and
converting the feature quantity determined to be converted, using a predetermined conversion function.

9. A non-transitory computer-readable capturing medium having captured therein a work set selection program for causing a computer to execute:
a sorting process of sorting feature quantities that correspond in a respective manner to a plurality of parameters to be optimized; and
a selection process of selecting, as a work set that is a set of parameters that has been partially optimized, a set of parameters that correspond respectively to a predetermined number of the sorted feature quantities arranged in ascending order beginning with the first feature quantity and including the first feature quantity, or a set of parameters that correspond respectively to the predetermined number of the sorted feature quantities arranged in descending order beginning with the last feature quantity and including the last feature quantity.

10. The medium having captured therein the work set selection program according to claim 9, for causing the computer to execute:
a determination process of determining, for each of the feature quantities that correspond in a respective manner to the plurality of parameters, whether to convert the feature quantity, according to a predetermined condition; and
a conversion process of converting the feature quantity determined to be converted, using a predetermined conversion function.

11. The work set selecting device according to claim 2, comprising
a decision unit which decides a representative value of the feature quantities.

12. The work set selecting device according to claim 3, comprising
a decision unit which decides a representative value of the feature quantities.

13. The work set selecting device according to claim 2, comprising
a belongingness determination unit which determines, for each of the plurality of parameters, whether the parameter belongs to a predetermined set.

14. The work set selecting device according to claim 3, comprising
a belongingness determination unit which determines, for each of the plurality of parameters, whether the parameter belongs to a predetermined set.

15. The work set selecting device according to claim 4, comprising
a belongingness determination unit which determines, for each of the plurality of parameters, whether the parameter belongs to a predetermined set.

16. The work set selecting device according to claim 11, comprising
a belongingness determination unit which determines, for each of the plurality of parameters, whether the parameter belongs to a predetermined set.

17. The work set selecting device according to claim 12, comprising
a belongingness determination unit which determines, for each of the plurality of parameters, whether the parameter belongs to a predetermined set.

18. The work set selecting device according to claim 2, wherein the optimization is performed by a support vector machine.

19. The work set selecting device according to claim 3, wherein the optimization is performed by a support vector machine.

20. The work set selecting device according to claim 4, wherein the optimization is performed by a support vector machine.
